(19) United States
(12) Patent Application Publication
(10) Pub. No.: US 2025/0325000 A1
(43) Pub. Date: Oct. 23, 2025

(54) PEA PROTEINS HAVING A MILKY FLAVOR

(71) Applicant: ROQUETTE FRERES, Lestrem (FR)

(72) Inventors: Aline LECOCQ, MOUVAUX (FR); Bernard CAULIER, FRETIN (FR)

(21) Appl. No.: 18/871,346

(22) PCT Filed: Jun. 5, 2023
(86) PCT No.: PCT/EP2023/025265

§ 371 Date: Dec. 3, 2024

(30) Foreign Application Priority Data
Jun. 3, 2022 (FR) 2205390

(51) Int. Cl. A23J 1/14; A23C 11/10; A23C 20/02; A23J 3/22

(52) U.S. Cl. CPC A23J 1/14; A23C 11/103; A23C 20/025; A23J 3/227

(57) ABSTRACT

The present invention relates to pea proteins having a milky aromatic profile, to a method for producing said pea proteins, and to the use of said proteins for producing food or beverage products, in particular plant-based alternatives to milk.

### FIELD OF THE INVENTION

The invention relates to novel pea proteins having a milky flavor profile. Another subject matter of the invention relates to a method for producing these pea proteins. The invention also relates to the use of said proteins in the production of food products.

### PRIOR ART

Daily requirements for proteins are generally between 12 and 20% of food intake. These proteins are provided equally by products of animal origin (meat, fish, eggs, dairy products) and by plant-based food (cereals, leguminous plants, seaweed).

In developed countries, protein intake is still today predominantly in the form of proteins of animal origin. These proteins have good nutritional properties and interesting functional properties, which allow them to be used in a very wide variety of food products.

However, numerous studies show that excessive consumption of proteins of animal origin to the detriment of plant proteins is one of the causes of increases in cancer and cardiovascular diseases. Moreover, animal proteins have many drawbacks, both in terms of their allergenicity (especially proteins from milk or eggs) and in environmental terms, in connection with the harmful effects of intensive farming.

Thus, there is an increasing demand from manufacturers for proteins of plant origin having beneficial nutritional and functional properties without, however, having the disadvantages of proteins of animal origin.

Since the 1970s, the pea is the pulse plant which has been the most developed in Europe, predominantly in France, especially as a protein resource intended for animal and human food. The pea contains approximately 27% by weight of protein substances. The term “pea” is considered here in its broadest accepted use and includes, in particular, all the wild varieties of “smooth pea” and all the mutant varieties of “smooth pea” and “wrinkled pea”, regardless of the uses for which said varieties are usually intended (human food, animal feed and/or other uses). Pea protein, predominantly pea globulin, has been extracted and utilized industrially for a great number of years. Mention may be made, as an example of a method for extracting pea protein, of patent EP1400537. In this method, the seed is milled in the absence of water (method referred to as “dry milling”) in order to obtain a flour. This flour is then suspended in water at room temperature to then proceed with the various steps for extracting the protein.

Despite its undeniable qualities, protein extracted from peas suffers, compared with other proteins, from undesirable flavor notes that can limit its use in certain applications. Furthermore, while a number of plant-based alternatives to milk have been developed in recent years—including soy, rice and oat—, pea plant-based alternatives to milk have so far met with little commercial success.

These flavor notes are very specific to the pea source and distinct from other plant sources. In particular, one of the main flavor notes generally found in many proteins on the market is “pea” or “beany”. This flavor note is an undeniable hindrance in many applications, particularly food. Following numerous studies, it has been demonstrated that one of the main causes for this pea flavor note comes from the synthesis of volatiles such as aldehydes and/or ketones (in particular hexanal) following the action of an internal lipoxygenase on the lipids present in the pea seed, in particular during the extraction of the proteins. Saponins and 3-alkyl-2-methoxypyrazines are also classes of compounds generating these unwanted flavors (“Flavor aspects of pulse Ingredients”, Wibke S.U. Roland, 2017). The article by Gao et al. “Effect of alkaline extraction pH on structure properties, solubility, and beany flavor of yellow pea protein isolate, Food Research International, May 2020, 131 (4)” also arrives at a correlation between lipoxygenase inhibition and a decrease in volatiles.

Moreover, protein extracted from peas often has a marked bitter aftertaste (or “off-note”).

For example, to improve the taste of plant proteins, a long-established solution is to reduce the lipid content by using organic solvents, thereby limiting the generation of the volatiles mentioned hereinbefore. The organic solvent can be used on the flour or on the protein obtained directly. Mention may be made in this regard of patent application WO2021174226, which illustrates this technique. However, this document does not describe pea protein having a milky flavor note.

Persons skilled in the art have developed several solutions that make it possible to improve the flavor of a pea protein and to give it a neutral taste. A first solution is based on masking the flavor by adding compounds selected for this purpose: this solution compels the user to introduce into their formulation a compound that they did not necessarily want to introduce and moreover requires labelling in the ingredients.

Another solution is described in patent U.S. Pat. No. 4,022,919, which teaches that treating pea flour with steam makes it possible to obtain a flour with improved flavor. Nevertheless, this method can be criticized for the risk of modifying the functional qualities of the proteins obtained by thermal denaturation (for example, the loss of solubility or the increase in its hydration capacity) and gelling of the starch comprised in the flour. Here again, the document makes no mention of a milky note.

Other solutions have been explored, including but not limited to, the selection of pea cultivars with less lipoxygenase or the pre-sprouting of peas prior to protein extraction.

The use of long-term soaking of the pea prior to milling and protein extraction has also been described. One example is patent application WO2015071499, which teaches a method that comprises soaking for several hours with lactic acid bacteria at 40° C. However, these solutions are not yet satisfactory. This lengthy, complex method, which consumes large amounts of water due to lactic fermentation, does not yet make it possible to obtain a pea protein with a completely neutral flavor (see table 10, where the smell and/or taste of peas are noted in every extract), nor does it make it possible to obtain a milky flavor note.

Mention may be made of patent application WO2017/120597, which discloses a method that includes precipitating the pea protein by the addition of salts, multiple washings, and recovery by centrifugation. Despite a complex method using large amounts of water (up to 30 times the amount of pea), the “pea” and “bitter” flavors are still present in the pea protein (see graphs 18A, B and C). Once again, this document makes no mention of the milky flavor note of the pea protein. Moreover, when formulating a plant-based alternative to milk, the formulation of the finished product may also comprise several flavorings. However, there is an interest in doing without these flavorings for reasons of simplicity in the labeling of this finished product. Moreover, these flavorings can be expensive. Finally, these flavorings can be difficult to proportion in order to achieve the desired result.

The applicant has also explored numerous other strategies for improving the taste of legume proteins, including pea. By way of example, mention may be made of documents WO2020/260841 and WO2020/240144, which describe the production of pea protein with improved taste. In these documents, no milky notes are mentioned for the taste of the pea proteins manufactured. Also, document WO2019/053387, in the name of the Applicant, discloses a method for producing pea proteins with a reduced pea flavor note, said method comprising blanching the seeds at 70° C. to 90° C. for 2 to 4 minutes before cooling, milling the seeds and then extracting the pea protein. This document does not describe the production of pea protein having a milky flavor note: although this flavor note was presented (among other notes) to the panel, the latter did not use it to characterize the taste of the protein.

The use of enzymes modifying the primary structure of the protein, such as glutaminases or proteases, can also modify the organoleptic properties of the proteins, including their taste; methods for producing modified pea proteins using such enzymes have thus already been disclosed. By way of example, mention may be made of patent application US2021/0401022 A1, which discloses such a method. The milky note is mentioned in table 2 of the sensory evaluation. Apart from the fact that the pea protein obtained is modified in its primary structure, another disadvantage of using an enzyme such as glutaminase is that it converts glutamine and produces ammonia, which consequently reduces the amount of protein nitrogen in the pea protein.

Thus, while it appears that research has been carried out to reduce the pea taste and bitter aftertaste of the protein, or even to try to achieve a protein with as neutral a taste as possible, it has to be said that none of the aforementioned documents has sought (or managed) to provide pea proteins having a milky flavor profile, while keeping the pea protein unmodified and without adding any additional flavoring. Furthermore, this is also confirmed by the fact that the pea proteins on the market do not have a milky flavor profile, as demonstrated in the examples section.

According to the present application, “flavor profile” refers to the set of flavor descriptors determined by a trained tasting panel, which represent the flavor profile of a product. A milky flavor profile means that the milky note has been identified by the tasting panel among the top three main flavor notes, or even as the first or second flavor note when the protein is tasted after suspension in water. A milky note refers to an flavor note associated with milk and/or yogurt.

However, there is precisely a need for such proteins, which can be advantageously used, for example, in plant-based alternatives to milk, in order to obtain milkier organoleptic properties.

After a great deal of research, the Applicant has come up with a novel production method that makes it possible to supply pea proteins with a very slight pea flavor note and very low bitterness as well as a milky flavor profile, all without the addition of flavorings. This is obviously an advantage for the production of products such as pea plant-based alternatives to milk. Moreover, as the flavor profile of the pea protein thus obtained is unique, even in food products other than plant-based alternatives, its use can make it possible to modify the taste and flavor of end products that use pea proteins in their composition. According to one variant, the Applicant has also succeeded in obtaining novel pea proteins that enable excellent texturing when used in extrusion, especially in wet extrusion. These pea proteins are particularly advantageous for the production of meat or fish analogues.

### SUMMARY OF THE INVENTION

Thus, the invention relates to a method for producing pea protein, comprising the following steps:
a) introducing peas or milled peas into an aqueous solution having a temperature between 65° C. and 90° C. in order to obtain a water/pea suspension or a water/milled pea suspension;
b) heat treating the suspension obtained in step a) at a temperature between 40° C. and 65° C. for 1 to 10 min;
c) in the case of a water/pea suspension, wet milling the water/pea suspension obtained in step b) in order to obtain an aqueous suspension of milled peas;
d) extracting a protein fraction by solid-liquid separation from the aqueous suspension of pea obtained in step b) or c);
e) optionally adjusting said protein fraction obtained in step d) to a pH between 2.0 and 8.0, for example between 4.5 and 5.7;
f) heat treating the protein fraction obtained in step e) at a temperature ranging from 65 to 90° C. for a time ranging from 1 to 120 seconds in order to form a coagulated pea protein suspension;
g) performing solid-liquid separation of the suspension of coagulated proteins obtained in step f) in order to form the pea protein.

Advantageously, the extraction step d) is preceded by a step do) of cooling the suspension to a temperature below 15° C., preferentially to a temperature of 4° C. to 14° C., for example of 10° C. to 12° C.

Advantageously, the cooling step do) is carried out by passing the aqueous suspension of milled peas through a heat exchanger.

Advantageously, the method comprises, following the heat treatment step f), a step f1) of cooling the suspension of coagulated proteins by rapid cooling.

Advantageously, the method comprises a step of adjusting the pH of the pea protein to a pH of between 6 and 7.5, preferably between 6.5 and 7.5.

Advantageously, the method comprises a step of additional heat treatment of the pea protein.

Advantageously, the method comprises a step of shearing the pea protein, for example by passing it through a high-pressure pump.

Advantageously, the method comprises a step of homogenizing the pea protein.

Advantageously, the method comprises a step of drying the pea protein.

Advantageously, the pH of the aqueous solution of step a) is adjusted to between 8 and 10.

Advantageously, the duration of the heat treatment of the protein fraction is between 1 and 45 seconds, most preferentially between 1 and 10 seconds.

Advantageously, the milled peas from step a) are obtained by dry milling.

Advantageously, a fraction rich in pea starch and/or a fraction rich in pea fiber is recovered from the insoluble part resulting from the solid-liquid separation step d).

Another subject matter of the invention is the pea protein that can be obtained by the method of the invention.

Advantageously, pea protein is characterized in that at least one of its first three CATA descriptors determined according to ISO 5492: 2008 (en), 4.23 is a milky descriptor. This pea protein can have low bitterness, a reduced pea flavor note and additionally a milky flavor profile. Without being bound by any theory, the applicant hypothesizes that this milky flavor profile can be explained by the presence of volatile compounds in the pea protein of the invention which are in different amounts and/or proportions than those of the pea proteins that are already known, some volatiles being able to be generated, some being reduced or eliminated by means of the steps of the method of the invention, especially the combination of the heat treatment steps. This is all the more remarkable as the method does not require the use of organic solvents or the use of enzymes, and pea proteins can also exhibit excellent functional properties, such as high solubility and/or gelling power.

Another subject matter of the invention also relates to the use of said pea protein for producing food or beverage products, especially plant-based alternatives to milk.

### BRIEF DESCRIPTION OF THE INVENTION

The invention relates to a method for producing pea protein.

### Step a)

Step a) comprises introducing peas into an aqueous solution. The peas used in step a) may have been previously subjected to steps that are well known to those skilled in the art, such as especially cleaning (removal of undesired particles such as stones, dead insects, soil residues, etc.) or even the removal of the external fibers of the peas (external cellulose hull) through a well-known step referred to as “dehulling”. Thus, “peas” in step a) refers to complete peas or pea cotyledons, from which the external hull has preferentially been removed. Alternatively, milled peas (i.e. pea flour) can be used, these milled peas generally being obtained by dry milling. Beforehand, the unskinned peas, the skinned peas or the pea cotyledons can undergo a toasting step, i.e. a dry heat treatment of the legume seeds. This dry heat treatment can be that of patent application WO2020/260841.

The aqueous solution may be water, and may also comprise additives such as anti-foaming or bacteriostatic compounds.

Especially, the ratio by weight of amount of peas to amount of aqueous solution in step a) can be between 0.5 and 2.

The temperature of the aqueous solution is between 65° C. and 90° C. Heating can be carried out using any installation well known to those skilled in the art, such as an immersed heat exchanger. Preferentially, the temperature is between 70° C. and 80° C. or even about 75° C.

The pea/water suspension or the milled pea/water suspension is obtained by introducing the pea or the milled peas into the pre-heated aqueous solution.

Alternatively, the pH of the aqueous solution of step a) is adjusted to between 8 and 10. This adjustment can be made by adding a base such as sodium hydroxide, lime or potash, preferentially sodium hydroxide. According to another variant, the pH is not adjusted in this step.

### Step b)

The method further comprises a heat treatment b) of the suspension obtained in step a) at a temperature of between 40° C. and 65° C. for 1 to 10 minutes. The suspension can be heated or cooled to reach this temperature. Alternatively, the suspension does not undergo any heating and is brought directly to the temperature when the aqueous suspension is mixed with the peas or the milled peas. Preferably, the heat treatment temperature is between 40° C. and 60° C., or even between 45° C. and 55° C. Preferentially, the heat treatment is carried out for 2 to 4 min.

### Step c)

If peas are used during step a), the method comprises a step c) of wet milling the pea/water suspension treated in step b) in order to obtain an aqueous suspension of milled peas. Preferably, the method is carried out using peas, and the wet milling step c) is carried out by continuous passage through one or more mills in order to obtain the aqueous suspension of milled peas. The one or more mills can be any type of mill suitable for wet milling, such as wet ball mills, wet conical mills, wet helical mills or wet mills equipped with rotor-stator systems. According to one variant, the mill can be the one used in the examples of document WO2019/053387 in the name of the Applicant. In the variant wherein the mill is of the rotor-stator type, this type of mill can allow continuous milling by passing the water/pea suspension through said mill. According to one preferred sub-variant, the method combines two cutting stages (pre-cutting then cutting) using different rotor-stator mills for each one of these cuts. The pre-cutting and cutting can be carried out one after the other or, alternatively, the cutting can take place after pre-cutting and storing the treated pea/water suspension. Such mills are disclosed in document WO2019/158589. Optionally, a dilution with water can be carried out during or at the end of this step in order to form the aqueous suspension of milled peas. Alternatively, during milling, water is added continuously or discontinuously to dilute the aqueous suspension. Generally, the solids content of the milled aqueous suspension ranges from 10% to 30%, for example from 15% to 25%.

### Step d)

Step d) of the method consists in extracting components from the aqueous suspension of milled peas, and in particular in extracting a protein fraction by solid-liquid separation from the aqueous suspension of pea. Alternatively, before carrying out the solid-liquid separation stage, a stage of adjusting the pH of the aqueous suspension of milled peas can be carried out. The solid-liquid separation can thus take place after adjusting the aqueous suspension of pea to a pH ranging from 6 to 9, preferentially from 8 to 9, most preferentially from 8.5 to 9. This pH adjustment stage can be carried out in a stirred tank. This stage can be shorter or longer, and last from 1 to 240 minutes, for example, generally from 5 to 60 minutes. To perform the pH adjustment, any type of acid and/or base, organic or inorganic, or mixtures thereof, can be added. Examples of acids that can be used include hydrochloric acid, sulfuric acid, citric acid or mixtures thereof. As an example of a base, mention may be made of sodium hydroxide, potash or lime and the mixtures thereof. This addition of base or acid and the pH measurement can be carried out online. The base and/or acid may be in the form of aqueous solutions. Advantageously, before this solid-liquid separation, and preferentially before the extraction step d), or even more preferentially before the extraction step d) and after the heat treatment step b) or the wet milling step c), the aqueous suspension of milled peas is cooled to a temperature below 15° C. This temperature can especially range from 4° C. to 14° C., for example from 10° C. to 12° C. This cooling step d0) can be carried out using known techniques, for example such as passing the aqueous suspension of milled peas through a heat exchanger.

Generally, the protein fraction is the soluble part of the aqueous suspension, and the starch- and fiber-rich fraction is the insoluble part. It is also possible to separate more than two insoluble fractions and, for example, to recover a first insoluble fraction that is richer in starch and a second insoluble fraction that is richer in fiber. Thus, according to one variant of the method, a starch-rich fraction and/or a fiber-rich fraction is recovered from the insoluble part resulting from the solid-liquid separation step d). Starch-rich fraction and fiber-rich fraction generally refers to a fraction comprising at least 50% of starch or fiber. The methods for quantifying starch and fiber are known to those skilled in the art, and specific methods are indicated later in the description. These fractions are conventionally recovered by the known separation methods. The solid-liquid separation may especially be carried out by means of at least one separation step with a decanter, especially a centrifugal decanter, a centrifuge or else with hydrocyclones. The method can likewise make it possible to recover one or more fiber- and/or starch-enriched fractions that are removed from the suspension and to recover the protein fraction that is useful for the rest of the method of the invention.

### Step e)

The method likewise optionally comprises a step e) of adjusting said protein fraction to the pH, which may optionally be the isoelectric pH of the protein. Isoelectric pH refers to a pH close to the one at which the net electrical charge of the protein in the protein fraction is zero. This pH can be adjusted to a pH between 2.0 and 8.0, for example between 4.5 and 5.7, or even between 4.8 and 5.2. The pH can be adjusted by adding an organic or inorganic acid, for example hydrochloric acid, sulfuric acid or citric acid, or mixtures thereof. This step e) can be carried out in a stirred or unstirred tank. It can be longer or shorter, and last from 1 to 240 minutes, for example, generally from 5 to 60 minutes. This addition of base or acid as well as the pH measurement can be carried out online, and the acid can be in the form of an aqueous solution.

### Step f)

The method also comprises a step f) of heat treating the protein fraction at an optionally adjusted pH. This step comprises a stage of heating the suspension of coagulated proteins. This stage is carried out at a temperature ranging from 65° C. to 90° C. to form a suspension of coagulated proteins. It can be carried out for a time ranging from 1 to 120 seconds, preferentially from 1 to 45 seconds, most preferentially from 1 to 10 seconds. A heat exchanger is generally used to carry out this heating. It can be of the type that uses the principle of indirect heating or the principle of direct heating, generally by steam injection. Preferably, the heating is performed by steam injection. Advantageously, the heat treatment step f) comprises a heating stage followed by a stage of cooling the suspension of coagulated proteins. In the variant wherein the heat treatment step f) comprises, following the stage of heating the suspension of coagulated proteins, a stage of cooling said suspension, this cooling stage is preferentially obtained by rapid cooling referred to as “flash-cooling”, leading to immediate cooling. At the end of this stage, the temperature can range from 60° C. to 75° C., for example between 64° C. and 70° C. This flash-cooling is achieved by applying a vacuum to the suspension of coagulated proteins, the vacuum applied being determined based on the chosen cooling temperature.

The applicant considers that the first steps b) and f) of heat treatment are essential to the method of the invention. Without being bound by any theory, one hypothesis is that pea protein may contain volatile compounds in certain proportions, which leads to giving it a milky flavor profile. It is likely that it is these first heat treatment steps b) and f), at particular temperatures, that generate this particular flavor profile, different from that of the pea proteins that are already known. It is possible that these steps could lead to a higher concentration of certain volatile compounds and, on the contrary, to a lower concentration of certain other volatile compounds, compared with the pea proteins that are already known. Together, they could produce this milky flavor profile, without needing to modify, for example, the primary structure of the protein.

### Step g)

In the rest of the method of the invention, the pea protein is separated from the suspension of coagulated proteins in step g). This solid-liquid separation can be carried out using the means indicated for the separation means indicated in step e). The pea protein formed during this step mainly comprises the proteins of the solid fraction, which are separated from the liquid fraction. The liquid fraction generally contains other proteins soluble at isoelectric pH, albumin and soluble carbohydrates. The recovered solid fraction comprises pea protein and is generally a concentrated aqueous suspension of pea protein. The solid fraction recovered has a solids content generally ranging from 25% to 50%, or even from 30% to 40%. The composition by weight of the pea protein can vary and will generally comprise mainly proteins (especially in the form of globulins) but also starch, lipids, fibers and/or sugars. This solid fraction can be diluted with water for easier handling in the subsequent optional steps.

### Other Steps

At the end of this step g), the method generally comprises a step g′) of adjusting the pH of the pea protein to a pH ranging from 6 to 7.5, generally from 6.5 to 7.5. This step can be carried out by adding an inorganic or organic base, such as by adding sodium hydroxide. The pH is generally raised by adding a basic aqueous solution.

Preferably, the method comprises a step of additional heat treatment of the pea protein. The temperature and time conditions can vary widely in this step, for example from 70° C. to 140° C. and lasting from 0.1 seconds to several minutes. According to a first variant of this step of additional heat treatment, the temperature ranges from 70° C. to 90° C. and its duration ranges from 0.1 seconds to 30 minutes. According to a second variant of this step of additional heat treatment, the temperature ranges from 90° C. to 110° C. and its duration ranges from 0.1 seconds to 5 minutes. According to another variant, this step of additional heat treatment is carried out at a temperature ranging from 110° C. to 140° C. for a time ranging from 0.1 to 30 seconds, preferentially from 0.2 to 15 seconds, for example from 0.3 to 10 seconds. The aim of this step may be to functionalize and/or sanitize the pea protein. To perform this step of additional heat treatment, the pea protein can be in the form of an aqueous dispersion, preferentially having a solids content ranging from 10 to 25%, for example from 15 to 20%. Advantageously, the method of the invention comprises, following the additional heat treatment step, a step f1) of cooling of the pea protein. According to one preferred variant, this cooling step is obtained by flash-cooling. At the end of this step, the temperature can range from 60° C. to 100° C., for example between 70° C. and 90° C. Similarly, this flash-cooling step is carried out by applying a vacuum to the aqueous dispersion of pea protein, the vacuum applied being determined based on the chosen cooling temperature.

As regards the functionalities of the pea protein, they can be modified by heat treatment. In particular, they are likely to be impacted by the choice of pH of the composition, which undergoes the additional heat treatment. For example, when the aqueous dispersion of pea protein has neutral pH during the heat treatment, the solubility of the pea protein obtained after this heat treatment is higher than that of a pea protein that was heat-treated at a slightly lower pH. Similarly, when the aqueous dispersion of pea proteins has neutral pH during the heat treatment, the gelling power of the pea protein obtained after this heat treatment may be lower than that of a pea protein that was heat-treated at a slightly lower pH. This is reflected in the examples section hereinafter.

According to one variant of the method, it comprises a step of shearing the pea protein, for example by passing the aqueous dispersion of proteins through a high-pressure pump. As examples of high-pressure pumps, mention may be made of the high-pressure pumps marketed by Silverson, also referred to as “high shear mixers”, such as those in the UHS range. Preferably, the shearing step is performed by a high-pressure pump.

The shearing step can take place before or after the steps of heat treatment and/or raising the pH.

According to another variant, the method comprises a step of homogenizing the pea protein.

Any type of homogenizer can be used to perform this homogenization step. According to the invention, it refers to equipment comprising a high-pressure pump and a homogenizing head, wherein the equipment is designed so that the product to be homogenized passes under pressure through this homogenizing head. A homogenizing head consists of a reduced opening, generally comprising a seat, a valve and an impact ring. Passing the aqueous dispersion of pea protein through the homogenizer can thus make it possible to homogenize the pea protein. The homogenization can be low-pressure homogenization, high-pressure homogenization or ultra-high-pressure homogenization. Depending on the homogenization technique used, the homogenization pressure can vary widely from 1 to 1000 bar, for example from 20 to 800 bar. According to one variant, the homogenization pressure ranges from 20 to 200 bar, for example from 50 to 150 bar. According to another variant, the homogenization pressure ranges from 200 to 800 bar, for example from 300 to 800 bar. According to one variant, the homogenization is a single-action homogenization. According to another variant, the homogenization is a multiple-action homogenization, for example a double-action homogenization. The homogenizers that can be used are marketed by GEA or Tetra Pak, for example.

The homogenization step can take place before or after the steps of heat treatment and/or raising the pH.

The method according to the invention can also comprise a step of drying the pea protein. Generally, this drying step is carried out so as to reach a solids content greater than 80%, preferentially greater than 90%, most preferentially greater than 94% by weight of solids relative to the weight of said pea protein. To this end, any technique well known to those skilled in the art can be used, for instance freeze-drying, flash drying or drying on a drying cylinder, or atomization. The process may also comprise a step of milling or micronizing. Atomization is the preferred technology, in particular multiple-effect atomization. The pea protein may be in the form of a powder having a particle size d50, which can vary widely, for example from 10 μm to 500 μm, generally from 50 μm to 150 μm.

“Pea protein” refers to a pea extract that can be produced according to the method of the invention, the protein of which consists of pea protein. Generally, the protein content by weight is 60% or more, advantageously 80% or more, for example from 80% to 95%, especially from 80 to 90%. The protein content is the N6.25 content, calculated using the Dumas method. It obviously generally comprises other minority constituents other than proteins, such as starch, lipids, fibers, and/or sugars. Generally, the total starch content in the pea protein produced according to the method of the invention ranges from 0% to 20%, for example from 0% to 10%, especially from 0.5% to 5%. This total starch content can be measured using the AOAC 996.11 method. Generally, the total fiber content may range from 0% to 20%, for example from 1% to 18%, in particular from 2% to 10%. This content can be determined by the AOAC 2017.16 method. Generally, the total lipid content is from 0% to 15%, for example from 1% to 10%. The total lipid content can be determined by the AOAC 996.06 acid hydrolysis method. The sugar content may range from 0% to 10%, generally from 0.5% to 5%. The sugar content can be determined by high performance liquid chromatography (HPLC).

The pea protein can have a milky flavor profile. Without being bound by any theory, this could be explained by the higher concentration of certain volatile compounds and, on the contrary, a lower concentration of certain other volatile compounds. According to one embodiment, the 3-methyl butanal content is less than 3,000 ppb, for example less than 2,500 ppb. According to a further embodiment that can be combined with the preceding embodiment, the benzaldehyde content is less than 60 ppb, for example, less than 50 ppb.

The properties of the pea protein can vary widely, depending on the method parameters previously described and as shown in the examples section.

According to one embodiment, the dried pea protein has a solubility at pH 7 ranging from 10% to 99%. The solubility may have all the intermediate amounts (that is, 11%, 12%, 13% . . . 97%, 98%, 99%) and the skilled person will know, on the basis of the method indications given hereinbefore and in the examples section, how to modify the parameters of the method within the indicated ranges in order to achieve the desired solubility. Advantageously, the dried pea protein has a solubility ranging from 5% to 100%, especially from 40% to 95%. According to a first variant, the solubility ranges from 75% to 100%, for example from 80% to 95%. According to a second variant, the solubility ranges from 40% to 75%.

### Solubility: Test A

Solubility is determined using the TEST A method described hereinafter:

### Measuring the Solubility in Water

This measurement is based on the dilution of the sample in distilled water, its centrifuging and the analysis of the supernatant.

### Procedure:

Introduce 150 g of distilled water into a 400 ml beaker at 20° C.±2° C., mix with a magnetic stirrer bar, and add precisely 5 g of the sample to be tested.
Adjust the pH to the desired value with 0.1 N NaOH or HCl (pH 7), or do not adjust it.
Complete water content at 200 g.
Mix for 30 minutes at 1000 rpm and centrifuge for 15 minutes at 3000 g.
Collect 25 g of the supernatant.
Introduce into a previously dried and tared crystallizer.
Place in an oven at 103° C.±2° C. for 1 hour.
Then place in a desiccator (with desiccant) to cool to ambient temperature and weigh.

The soluble dry matter content, expressed in % by weight, is given by the following formula:

$$\frac{( m 1 - m 2 ) \times ( 200 + P ) \times 100}{P 1 \times P} = \% solubility \qquad [ Math . 1 ]$$

wherein:
P=weight, in g, of the sample=5 g
m1=weight, in g, of the crystallizer after drying
m2=weight, in g, of the empty crystallizer
P1=weight, in g, of the sample collected=25 g

According to one embodiment, the dried pea protein can have gelling power. This gelling power can range from 1 to 500 Pa, for example from 100 to 500 Pa.

### Gelling Power: Test B

The term “gelling power” refers to the functional property which consists of the capacity of a protein composition for forming a gel or a network, which increases the viscosity and generates a state of matter between the liquid and solid states. The term “gel strength” may also be used. To quantify this gelling power, it is thus necessary to generate this network and to evaluate its strength. To perform this quantification, in the present invention, test B is used, the description of which is as follows:
1) Solubilization at 60° C.±2° C. of the protein composition tested in water at 15%+/−2% of solids and at pH 7;
2) Stirring for 5 min at 60° C.±2° C.;
3) Cooling to 20° C.±2° C. and stirring for 24 hours at 350 rpm;
4) Implementing the suspension with a controlled stress rheometer equipped with a concentric cylinder;
5) Measurement of the elastic moduli G′ and the viscous moduli G″ by applying a following temperature profile:
a. Phase 1: measurement of the parameter G′1 after stabilization at 20° C.±2° C. and heating from a temperature of 20° C.±2° C. to a temperature of 80° C.±2° C. in 10 minutes;
b. Phase 2: stabilization at a temperature of 80° C.±2° C. for 110 minutes;
c. Phase 3: cooling from a temperature of 80° C.±2° C. to a temperature of 20° C.±2° C. in 30 min and measurement of G′2 after stabilization at 20° C.±2° C.;
6) Calculation of the gelling power equal to G′2-G′1.

In a preferred manner, the controlled stress rheometers are chosen from the models DHR 2 (TA, Instruments) and MCR 301 (Anton Paar), with a spindle of concentric cylinder type. They are equipped with a temperature regulation system based on the Peltier effect. In order to avoid evaporation problems at high temperature, liquid paraffin is added on top of the samples.

For the purposes of the invention, a “rheometer” is a laboratory machine for taking measurements regarding the rheology of a fluid or a gel. It applies a force to the sample. Generally of characteristic small dimensions (very small mechanical inertia of the rotor), it allows fundamental study of the mechanical properties of a liquid, a gel, a suspension, a paste, etc., in response to an applied force.

The so-called “controlled stress” models make it possible, by the application of a sinusoidal stress (oscillation mode), to determine the intrinsic viscoelastic values of matter, which notably are dependent upon time (or angular velocity ω) and upon temperature. In particular, this type of rheometer makes it possible to access the complex modulus G*, which itself makes it possible to access the moduli G′ or elastic part and G″ or viscous part;

The first three steps consist in resuspending the protein in water, using precise conditions making it possible to maximize the subsequent measurement.

The chosen water is preferentially reverse osmosis water, but drinking water may also be used.

Its temperature is 60° C.±2° C. during the initial resuspension (1st and 2nd steps) and then 20° C.±2° C. after solubilization for 24 h and cooling before the measurement (3rd step). In general and unless indicated otherwise, when a temperature is given in the present description, it always comprises a variation of +2° C., for example 20° C.±2° C. or 80° C.±2° C.

A defined amount of protein is added to said water so as to obtain a suspension containing 15%±2% of solids. To do this, equipment such as beakers and stirring bars, well known to those skilled in the art, are used. A volume of 50 mL is stirred for at least 10 h at 350 rpm at room temperature. In general and unless indicated otherwise, the solids contents given in the present description always comprise a variation of +2%, for example 15%±2%. The pH is adjusted to 7±0.5 using a pH-meter and acid-base reagents, as is well known in the prior art.

The fourth step consists in introducing the sample into the rheometer, and covering said sample with a thin layer of oil in order to limit the evaporation.

During the fifth step, the following temperature protocol is then applied: a. Phase 1: heating from a temperature of 20° C.±2° C. to a temperature of 80° C.±2° C. in 10 minutes; b. Phase 2: stabilization at a temperature of 80° C.±2° C. for 110 minutes; c. Phase 3: cooling from a temperature of 80° C.±2° C. to a temperature of 20° C.±2° C. in 30 min.

The measurement of the parameter G′ is performed continuously during this protocol and is recorded.

The sixth and last step of test B consists in exploiting the recording. Two values are extracted: G′1=value of G′ at the start of phase 1 after stabilization at 20° C.±2° C. and G′2=value of G′ at the end of phase 3 after stabilization at 20° C.±2° C.

The gelling power is equal to G′2-G′1.

According to one variant, the pea protein is an enzymatically modified protein. With enzymatically modified protein, the skilled person refers to a protein whose protein structure has been deliberately modified by the addition to the protein of at least one enzyme capable of modifying the protein structure. This enzyme can be chosen from proteases, peptidases, deamidation enzymes, such as those of the E.C. 3.5.1 type, like glutaminase, or deimination enzymes, such as those of the E.C. 3.5.3 type, like peptidylarginine deiminase. These protein-modifying enzymes are known for modifying the physicochemical and/or organoleptic properties of the protein. For example, it is known from document WO2019/233920 A1 that peptidylarginine deiminase reduces the astringency, especially the astringency of rapeseed protein. If the method comprises proteolysis of the protein-enriched fraction, this can modify the degree of hydrolysis (DH) of the protein. Preferably, the degree of hydrolysis is less than 15%, advantageously less than 10%, preferably less than 6%, for example between 3% and 5%. A person skilled in the art will know how to adapt the enzymatic proteolysis conditions, or even will not carry out such a step in order to obtain the desired DH. According to a preferred embodiment of the invention, the pea protein is not enzymatically modified by deamidation. According to a preferred embodiment of the invention, the pea protein is not enzymatically modified by deamination. Glutaminase also makes it possible to perform a deamination step. According to another preferred variant of the invention, the protein is not enzymatically modified. One advantage of the invention is that it is possible to modify the organoleptic properties of pea protein, and especially to give it a milky flavor profile, without even needing to modify the protein enzymatically. According to one embodiment, the invention also makes it possible to provide proteins with an unmodified primary structure.

Pea Protein that can be Obtained by the Method of the Invention

Another subject matter of the invention relates to a pea protein that can be obtained by the method of the invention. As previously explained, the protein of the invention has a unique milky flavor profile for pea proteins. Without being bound by any theory, the applicant hypothesizes that this milky flavor profile can be explained by the presence of volatile compounds in the pea protein of the invention which are in different amounts and/or proportions than those of the pea proteins that are already known, some volatiles being able to be generated, some being reduced or eliminated by means of the steps of the method of the invention, especially the combination of the heat treatment steps. This is all the more remarkable in that the method does not require the use of organic solvents or the enzymatic modification of the protein to obtain this milky flavor profile. Advantageously, the pea protein that can be obtained by the method of the invention is characterized in that at least one of its first three CATA descriptors determined according to ISO 5492: 2008 (en), 4.23 is a milky descriptor.

### Pea Protein Having a Milky Descriptor Among its First Three CATA Descriptors

Another subject matter of the invention relates to a pea protein characterized in that at least one of its first three CATA descriptors determined according to ISO 5492: 2008 (en), 4.23 is a milky descriptor.

### Use of Pea Protein

Another subject matter of the invention is the use of the pea protein of the invention for producing food or beverage products, especially plant-based alternatives to milk.

Generally, the pea protein of the invention can be used in food products and beverages that may include it in an amount up to 100% by weight relative to the total dry weight of the food or beverage product, for example in an amount ranging from about 1% by weight to about 80% by weight relative to the total dry weight of the food or beverage product. All intermediate amounts (that is, 2%, 3%, 4% . . . 77%, 78%, 79% by weight relative to the total weight of the food or beverage product) can be used, as well as all the intermediate ranges based on these quantities. These food and beverage products can be adapted to vegetarian or vegan populations.

A particularly interesting use of the protein of the invention relates to its use in beverages which have a more pleasant taste than those obtained from other commercially available pea proteins. The pea protein of the invention can advantageously be used to produce beverages, in particular milk alternatives, or in other words milk substitutes. Moreover, because of the milky flavor note due to the ingredient, these beverages can also have a more milky flavor note than a beverage not comprising said protein, which is an undeniable advantage for the production of plant-based alternatives to milk. In addition to improving the flavor, the invention also makes it possible to obtain a more velvety mouthfeel than when other pea proteins are used, which is advantageous for beverages, and especially for plant-based alternatives to milk, as animal milks generally have a velvety mouthfeel.

In beverages, the protein content of these products can vary widely, and can also be a high-protein drink. The protein content can range, for example, from 1% to 12% by dry weight, with respect to the total weight of the beverage, especially from 3% to 10% by dry weight, with respect to the total weight of the beverage. The beverages can be of any type, and include plant-based alternatives to milk or milk substitutes, including barista-type milks and coffee creamers. These may also include other acidic or non-acidic ready-to-drink beverages such as carbonated drinks (including, but not limited to, carbonated soft drinks), non-carbonated drinks (including, but not limited to, non-carbonated soft drinks such as flavored waters, fruit juices and sweetened or unsweetened tea or coffee-based drinks), alcoholic beverages such as beers or spirits, smoothies, and beverage concentrates (including, but not limited to, liquid concentrates and syrups, as well as non-liquid “concentrates” such as freeze-dried and/or powdered preparations or “powder mixes”). It should be noted that in beverages, flavorings or masking agents are generally used to reduce the pea flavor note or bitter aftertaste of the protein, or to flavor the beverage. One of the advantages of the pea protein of the invention is that its use in place of conventional pea proteins makes it possible to reduce this amount of flavoring or masking agent, or even to totally eliminate these constituents from the beverage altogether, while retaining a very satisfactory taste for the beverage. The beverages can also comprise hydrocolloids; however, since pea protein provides a more velvety texture, it is possible to reduce or even eliminate the hydrocolloid content while retaining a velvety mouthfeel.

The food products to which it may relate comprise bakery products such as bread products (including, but not limited to, sourdough and unleavened breads, sandwich loaves, yeast breads, and unleavened breads such as baking soda breads), breads containing all types of wheat flour, breads containing all types of flour other than wheat flour (such as potato, rice, barley, spelt, and rye flours), gluten-free breads; mixes for the preparation of said bakery products; sweet bakery products (including, but not limited to, rolls, cakes, pies, pastries, waffles, pancakes, muffins, pancakes, and cookies); mixes for the preparation of said sweet bakery products; pie fillings and other sweet fillings (including, but not limited to, fruit pie fillings and nut pie fillings such as pecan pie fillings, as well as fillings for cookies, cakes, pastries, confectionery products and others, such as cream fillings); and snack bars (including, but not limited to, energy, cereal, nut, and/or fruit bars).

They can also be jellied desserts such as dessert crèmes, custards and puddings. Another type of dessert can also be frozen desserts (including, but not limited to, frozen dairy desserts such as ice cream—including regular ice cream, soft ice cream and all other types of ice cream—and frozen non-dairy desserts such as non-dairy ice cream, sorbet, and others).

Other products conventionally prepared using animal milk can also comprise the pea protein of the invention to form substitutes. These products may be acidified and/or fermented with ferments, such as lactic, vegan, or mesophilic ferments. These may include yoghurts (including, but not limited to, full-fat, low-fat, and fat-free yoghurts, which may be milk protein-free and lactose-free). The term “yoghurt” also includes fromage frais and petits-suisses. It may also include cheese substitutes such as cheese spreads, melted cheeses, pressed cooked and uncooked cheeses, soft cheeses, spun cheeses, blue cheeses; it may include Emmental, string cheese, ricotta, provolone, Parmesan, Munster, mozzarella, Monterey Jack, Manchego, blue, fontina, feta, Edam, double Gloucester, Camembert, Cheddar, Brie, Asiago and havarti. It can also include other products such as plant-based butters and even crème fraîche.

Other products that can include the pea protein of the invention are sauces such as vinaigrettes or mayonnaise- or ketchup-based sauces or syrups.

Likewise, the pea proteins of the invention can be incorporated into confectionery products (including, but not limited to, jelly candies, soft candies, hard candies, chocolates, caramels, and gums); sweetened and unsweetened breakfast cereals (including, but not limited to, extruded cereals, flaked cereals, and puffed cereals); and cereal coating compositions for the preparation of breakfast cereals. These may also include sweet spreads (including, but not limited to, jellies, jams, nut butters such as peanut butter, spreads, and other spreadable products).

The pea proteins of the invention can also be used as flavor carriers or encapsulants.

Other types of food and beverages that are not mentioned herein but which conventionally comprise one or more proteins can also be envisaged in the context of the present invention. In particular, animal feed (such as pet food) is explicitly envisaged.

Pea protein can also be used, optionally after texturing, in meat substitutes such as emulsified sausages or hamburgers, or in fish or seafood substitutes. It can also be used in egg-replacement formulations or in the production of protein products such as tofu or tempeh. Textured proteins generally refers to proteins textured by extrusion, i.e. dry extrusion or textured vegetable protein, or high moisture extrusion. The extruders can be single-screw, twin-screw or multi-screw. In the case of twin-screw extrusion, the extrusion can be co-rotating or counter-rotating. As examples of multi-screw extrusion, mention may be made of the planetary extruder and the ring extruder. Other more specific technologies can include shear cell technology, microextrusion and 3D printing.

Food products or beverages can be used especially in specialized nutrition, for example for specific populations, such as babies or infants, children, adolescents, adults, the elderly, athletes, people suffering from a disease, etc. These may be meal-replacement formulas or complete nutritional beverages, for example for weight management or clinical nutrition (e.g. tube feeding or enteral nutrition).

The pea protein can be used as a single source of proteins, but can also be used in combination with other additional plant or animal proteins. These additional proteins may be hydrolyzed or non-hydrolyzed. These additional proteins are generally in the form of concentrates or isolates. The term “plant protein” denotes all the proteins derived from cereals, oleaginous plants, leguminous plants and tuberous plants, as well as all the proteins derived from algae and microalgae or fungi, used alone or as a mixture, selected from the same family or from different families. “Leguminous plants” generally refers, in the present application, to the family of dicotyledonous plants of the Fabales order. Several leguminous plants are significant crop plants, such as soybean, beans, especially the mung bean, chickpea, faba bean, groundnut, cultivated lentil, cultivated alfalfa, various clovers, broad beans, locust bean, licorice, and lupin. The additional legume protein can be selected from these legumes or else can be a pea protein such as that used in the invention. In the present application, the term “cereals” refers to plants cultivated from the family of grasses producing edible grains, for example wheat, oat, rye, barley, corn, sorghum, or rice. Tubers may be carrot, cassava, konjac, potato, Jerusalem artichoke, sweet potato. Oilseed plants are generally plants that produce seeds from which oil is extracted. Oilseed plants can be selected from sunflower, rapeseed, peanut, sesame, squash, or flax. The animal proteins can, for example, be egg or milk proteins, such as whey proteins, casein, or caseinate proteins. The pea protein composition of the invention can thus be used in association with one or more of these proteins or amino acids in order to improve the nutritional properties of the end product, for example to improve the PDCAAS of the protein or to provide other functionalities.

Pea protein can also be used for producing pharmaceuticals or in fermentation, for example for producing fungal metabolites or cell culture metabolites.

The invention and its advantages will now be illustrated in the embodiments detailed in the examples section hereunder. It should be noted that these examples do not limit the present invention.

### EXAMPLES

### Example 1: Pea Protein According to the Invention

About 900 kg of peas were used. The external fibers of the peas were first separated from the seeds by crushing (mechanically separating the external hull and the pea seeds) and skinning (sorting the external hulls and the skinned seeds using compressed air). Water at 75° C. was used in this first part of the method: pea seeds and water were fed continuously into a Bruynooghe immersed-screw blancher. The water/pea weight ratio was approximately 1. All of the water entered at the entrance to the blancher and the peas were immediately introduced into the water at 75° C. As soon as the peas were in contact with the water, the temperature of the water/pea suspension was about 55° C. The screw speed was set so that the peas passed through the blancher in 3 minutes, and the temperature remained stable during this period. Water was added at the outlet of the blancher to give a water/pea weight ratio of about 1.5. The water/pea suspension was immediately ground by continuous wet milling, introducing water at room temperature during milling, to obtain a milled pea suspension with about 20% solids content at a temperature of about 35° C. The milled pea suspension was adjusted to pH 8.5 by continuously adding sodium hydroxide online. The milled pea suspension was cooled to about 10° C. by passing through a plate heat exchanger and then transferred to a stirred storage tank. This milled pea suspension was fed into a centrifugal decanter (Flottweg Z3). The protein fraction was recovered from the overflow (about 7% solids content). The protein fraction was adjusted with hydrochloric acid to pH 5 in a stirred tank, then heat-treated by steam injection at 74° C. in a GEA skid for approximately 3 seconds, after a first immediate preheating step by passing through a plate heat exchanger. The protein fraction was then flash-cooled to 67° C. Immediately afterwards, the heat-treated protein fraction was passed over a Flottweg Z3 centrifugal decanter. The protein sediment (underflow) recovered was diluted in hot water (80° C.) so that it could be pumped. This sediment was then immediately adjusted to about 15% solids content and rectified to pH 7 with sodium hydroxide. The pea protein floc was heat-treated at 130° C. for 5 seconds, then cooled instantly by flash-cooling to about 75° C. This pea protein floc was passed through a 200-bar high-pressure homogenizer and then atomized in a TGE nozzle atomizer. The pea protein powder recovered was then analyzed.

### Example 2: Pea Protein According to the Invention

About 900 kg of peas were used. The external fibers of the peas were first separated from the seeds by crushing (mechanically separating the external hull and the pea seeds) and dehulling (sorting the external hulls and the skinned pea seeds using compressed air). Water at 75° C. was used in this first part of the method: peas and water were fed continuously into a Bruynooghe immersed-screw blancher. The water/pea weight ratio was approximately 1. All of the water entered at the entrance to the blancher and the peas were immediately introduced into the water at 75° C. As soon as the peas were in contact with the water, the temperature of the water/pea suspension was about 52° C. The screw speed was set so that the peas passed through the blancher in 3 minutes, and the temperature remained stable during this period. Water was added at the outlet of the blancher to give a water/pea weight ratio of about 1.5. The water/pea suspension was immediately ground by continuous wet milling, introducing water at room temperature during milling, to obtain a milled pea suspension with about 20% solids content at a temperature of about 35° C. The milled pea suspension was adjusted to pH 8.5 by continuously adding sodium hydroxide online. The milled pea suspension was cooled to about 10° C. by passing through a plate heat exchanger and then transferred to a stirred storage tank. This milled pea suspension was fed into a centrifugal decanter (Flottweg Z3). The protein fraction was recovered from the overflow (about 7% solids content). The protein fraction was adjusted with hydrochloric acid to pH 5 in a stirred tank, then heat-treated by steam injection at 74° C. in a GEA skid for approximately 3 seconds, after a first immediate preheating step by passing through a plate heat exchanger. The protein fraction was then immediately cooled by flash-cooling to 67° C. Immediately afterwards, the heat-treated protein fraction was passed over a Flottweg Z3 centrifugal decanter. The protein sediment (the underflow) recovered was diluted in hot water (80° C.) so that it could be pumped. This sediment was then immediately adjusted to a solids content of about 15% and rectified to pH 6.5 with sodium hydroxide. The pea protein floc was heat-treated at 120° C. for 10 seconds, then cooled by flash-cooling to about 75° C. This protein floc was atomized in a TGE nozzle atomizer. The pea protein powder recovered was then analyzed.

### Other Embodiments

Other embodiments of the invention are carried out and make it possible to obtain pea proteins with properties similar to those of example 1. For the sake of simplicity, the table hereunder lists the differences with respect to example 1 (same indicates no difference).

TABLE 1

| | | | | pH milled | pH | |
|---|---|---|---|---|---|---|
| | Water | | Processing | pea | protein | Heat |
| | temperature | Temp. susp. | time step | suspension | fraction | treatment |
| Ex | a) | Water/pea b) | b) | d) | e) | f) |
| 1A | 85° C. | 62° C. | 8 minutes | 7 | 5.5 | 90° C., 1 s |
| 1B | 70° C. | 51° C. | 4 minutes | same | same | same |
| 1C | 70° C. | 51° C. | 4 minutes | 9 | 4.5 | 70° C., 15 s |
| 1D | same | same | same | same | 5.2 | 72° C., 8 s |
| 1E | same | same | same | same | 4.8 | 65° C., 20 s |
| 1F | same | same | same | 8 | same | 90° C., 5 s |

### Analyses

TABLE 2

| Property | Example 1 | Example 2 |
|---|---|---|
| Dry material | 94.3% | 94.8% |
| N6.25 protein (% on a dry basis) | 85.6% | 87.3% |
| Solubility (pH 7) | 88.6% | 38.3% |
| Gelling power (Pa) | 5 | 198 |
| Viscosity 5 s−1 | 0.08 | 0.50 |
| Viscosity 40 s−1 | 0.06 | 0.10 |

### Commercial Pea Proteins

In addition to the pea protein of the invention (example 1), the following commercial pea proteins were sensorially evaluated:
NUTRALYS® S85F (ROQUETTE® Frères)
Pisane® C9 (Cosucra)
Puris® 870 (Puris)
Profam® (ADM)

### Comparative Pea Protein—Protein of the Background Art WO2019/053387 A1

0.8 kg of peas are used. The external fibers of the peas are first separated from the seeds by crushing (mechanically separating the external hull and the pea seeds) and skinning (sorting the external hulls and the seeds of the pea using compressed air). The peas are placed in a container holding 1.6 L of demineralized water heated to 80° C. The temperature of 80° C. is maintained for 3 minutes. The peas are separated from the aqueous solution by filtration through a 2-mm mesh sieve. The peas are then placed in a second container holding 1.6 L of demineralized water, the temperature of which is set to a temperature of 7° C. for 5 minutes. This cooling process is continued until the temperature of the peas is 10° C. or less. The peas are separated from the aqueous solution by filtration through a 2-mm mesh sieve. The peas, weighing 1.3 kg due to water absorption, are introduced into the chamber of a Robocoupe Blixer 4VV type mill. The pea is milled at maximum speed for 1.5 minutes. Then, while still milling at maximum speed, 2.7 L of demineralized water is added over a period of 3 minutes. Finally, milling is continued for a further 0.5 minutes. The end product is a water/pea homogenate with 20% solids content. This homogenate is centrifuged for 5 min at 5000 g. The supernatant, which concentrates the proteins, is adjusted to pH 5 and then heated to 60° C. for 10 min in order to flocculate the proteins. The protein floc is recovered by centrifuging at 5000 g for 5 min. The floc is resuspended in a volume of water making it possible to obtain a fluid suspension so that the pH can be adjusted to 7 with hydrochloric acid. This floc is then freeze-dried. The result is a pea protein with 81% of protein/solids and 95% solids content.

### Comparative Pea Protein—Protein of the Background Art WO2020/260841 A1

The following protein and starch extraction method is applied:
Whole peas placed in a ventilated oven under 4 conditions (2 min 80° C., 5 min 80° C., 2 min 120° C., and 5 min 120° C.)
Separating outer fibers and pea cotyledons
Grinding pea cotyledons with a stone mill
Suspending the flour in water at 17% solids content, 20° C.±2° C. and PH of 7±1
Shaking for 30 min
Separating the insolubles (starch and internal fibers) by centrifugation 1,000 G 5 min,
Rectifying the supernatant at pH 5
Heating to 55° C. for 20 min in a vessel equipped with a double jacket, and stirring,
Recovering the protein composition by centrifugation 5,000 G 5 min
Rectifying the pH to 7 with 1N NaOH
Heat-treating by direct injection 140° C. 10 seconds
Spray drying

### Sensory Evaluation of the Comparative and Commercial Pea Proteins

For each sensory test, the panelists were given a specific protocol to follow in order to rinse their mouths and avoid the saturation caused by solutions of pea protein isolates, in order to optimize the sensory analysis of this type of product. This method is described in the publication, which is incorporated by reference: Cosson, A., Delarue, J., Mabille, A.-C., Druon, A., Descamps, N., Roturier, J.-M., Souchon, I., & Saint-Eve, A. (2020). Block protocol for conventional profiling to sensory characterize plant protein isolates. Food Quality and Preference, 83, 103927.

### Evaluation in Water

TABLE 3

| | | Characterization of the |
|---|---|---|
| | Quantification | organoleptic profile |
| Samples | 4% of protein powder in Evian water | |
| | Tasting temperature: 20° C. | |
| | Random order | |
| | Blind products (3-digit codes) | |
| Panels | Expert panelists | Qualified panelists |
| | (training ≈ 20 h) | >25 panelists |
| | >12 panelists | |
| Methodology | Profile by | CATA (Check-All-That- |
| | quantitative | Apply)⁽²⁾ |
| | descriptive | |
| | analysis (QDA)⁽¹⁾ | |
| | Scale 0-10 | |
| Sensory attributes | Bitter | Tastes and |
| presented to the | Pea flavor | perceptions: sweet, |
| trained panel | | salty, sour, umami, |
| | | astringent, neutral |
| | | (with nose clip) |
| | | Texture: powdery, |
| | | mouthfeel (with nose- |
| | | clip) |
| | | Aromatic notes: |
| | | almond, broth, |
| | | cardboard, chemical, |
| | | cocoa, cooked cereal, |
| | | earthy, fatty, flour, |
| | | green, toasted, hay, |
| | | liquor, metallic, milky, |
| | | mushroom, nut, paint, |
| | | potato, pungent, |
| | | rancid, soap, |
| | | sulfurous, vegetable, |
| | | yeast, neutral |
| Statistical | Average + | Cochran test |
| analysis | standard deviation | Correspondence |
| | | analysis |
| | Analysis of | Marascuilo procedure |
| | variance - ANOVA | for multiple |
| | (α = 5%) | comparisons |

⁽¹⁾“Sensory analysis - Methodology - General guidance for establishing a sensory profile.” (ISO 13299: 2016)
⁽²⁾“Description of the sensory attributes of a sample but without intensity values” (ISO 5492: 2008(en), 4.23)

Sensory analysis using CATA methodology makes it possible to define the flavor profiles of proteins, each of which is listed in the table hereunder:

TABLE 4

| Protein | Three main descriptors |
|---|---|
| Protein of the invention | Milky, cereal, toasted |
| NUTRALYS ® S85F | Pea, potato, broth |
| Profam ® (ADM) | Sulfur, potato, chemical |
| Puris ® 870 (Puris) | Sulfur, pea, toasted |
| Pisane ® C9 | Pea, chemical, almond |

Among the proteins tested, only the protein of the invention has a milky descriptor, and this is even the first descriptor in the case of the protein of the example.

Furthermore, some of the comparative proteins (Profam® (ADM), Puris® 870 (Puris), Pisane® C9) have unpleasant main descriptors, such as the sulfur and/or chemical descriptor, unlike the protein of the invention.

As for the comparative pea protein of patent application WO2019/053387 A1, the milky descriptor was not identified by the panel, and this protein thus also lacks a milky flavor profile. Similarly, the panel does not determine a milky flavor profile for each of the four proteins manufactured according to patent application WO2020/260841 A1.

Moreover, the protein of the invention has very low pea and bitter notes, and thus ranks at the top of the best proteins with regard to these two criteria.

### Plant-Based Alternative to Milk

### Preparation

Plant-based alternatives to milk were manufactured using the recipe hereunder:

TABLE 5

| Ingredient | wt. % |
|---|---|
| Water | 90.08 |
| Pea protein of example 1 | 6.20 |
| Sunflower oil | 1.50 |
| Powdered cane sugar | 2.00 |
| Sunflower lecithin | 0.10 |
| Gellan gum | 0.12 |
| Total | 100 |

Nine liters of plant-based alternative to milk are prepared using the following protocol:
1. Disperse the powders in water heated to 70° C.
2. Hydrate the mixture under gentle stirring for 30 minutes (2500 rpm in a Silverson mixer) to form an aqueous protein solution
3. Heat the oil to 65° C. and disperse the lecithin, stirring for 3 minutes.
4. Add the oil and lecithin mixture to the aqueous solution and stir vigorously for 5 minutes (6000 rpm in a Silverson mixer)
5. Sterilize: 142° C. for 5 seconds
6. Homogenize the sterilized solution at 75° C. in a high-pressure homogenizer (170 bar-1st stage/30 bar 2nd stage)
7. Cool to 4° C. and bottle

The same type of recipes were produced using commercial pea proteins: NUTRALYS® S85F (ROQUETTE® Frères) and PURIS® Pea Protein P870 (PURIS®).

### Texture and Color

The plant-based alternatives to milk of the invention have an excellent texture and satisfactory color.

### Sensory Analysis

The plant-based alternative to milk of the invention has fewer pea flavor notes, less astringency and less bitterness than plant-based alternatives made with commercial pea proteins.

Moreover, the plant-based alternative to milk of the invention is the only one to feature the milky note as the main flavor note in its flavor profile, which is explained by the milky flavor profile of the protein of the invention.

### Addition of Masking Agents to the Plant-Based Alternative to Milk

An amount of 0.08% of masking agents was added to the reference plant-based alternative to milk in order to improve its flavor (i.e. about 1.3 wt. % of NUTRALYS® S85F pea protein). However, even with this addition, the pea and bitter notes of the plant-based alternative to milk of the invention are much weaker than those of the reference plant-based alternative comprising this masking agent. Furthermore, the plant-based alternative to milk of the invention remains the only one to feature a milky flavor note.

### Powder Mix

### Preparation

The powder mixes were manufactured using the recipe hereunder:

TABLE 6

| Ingredient | wt. % |
|---|---|
| Pea protein of example 1 | 88.5% |
| GLUCIDEX ® IT 19 maltodextrin | 10.6% |
| Sunflower lecithin | 0.7% |
| Xanthan gum | 0.1% |
| Intense sweeteners | 0.1% |

The pea protein of the invention is evaluated along with the NUTRALYS® S85F (ROQUETTE® Frères) commercial pea protein, also in the powder mix recipe.

40 g of powder mix is placed in 325 mL of Evian® brand water.

After stirring in the shaker, it is noted that in both cases, after 15-25 minutes:
no sedimentation is observed
the amount of foam is low and very acceptable
no lumps are observed
the viscosity remains stable over time

### Sensory Analysis

The powder mix made with the protein of example 1 has a milky note identified as the most important by the panel. It also has a pleasantly more velvety mouthfeel than the powder mix made from commercial pea protein.

As in the case of pea proteins evaluated in water, an improvement in taste is also noted for the powder mix comprising the protein of the invention compared with that comprising the commercial product, as regards the bitter note and the pea note, which are much reduced.

### Addition of Masking Agents to the Reference Powder Mix

An amount of 1.2% of masking agents was added to the reference powder mix in order to improve its flavor (i.e. about 1.3 wt. % of pea protein). However, even if, with this addition, the pea and bitter notes of the reference powder blend are improved and can be quite close to the pea and bitter notes of the powder blend of the invention, the powder blend of the invention remains the only one to have a milky flavor note. Moreover, it is thus possible to provide a powder mix having very low pea and bitter notes, without the addition of a masking agent which adds cost to the formulation of the powder mix and which also has to be labelled.

### Plant-Based Alternative to Pizza Cheese

### Preparation

Plant-based alternatives to pizza cheese were manufactured using the recipe hereunder:

TABLE 7

| Ingredient | Weight (g) |
|---|---|
| Water | 434 |
| Pea protein of example 1 | 50 |
| Sunflower oil | 230 |
| ROQUETTE N-200 waxy corn | 100 |
| starch | |
| CLEARGUM ® PG 90 20 modified | 166 |
| starch | |
| NaCl salt | 17 |
| Anhydrous citric acid | 3 |

The pea protein of the invention is evaluated along with the NUTRALYS ® S85F (ROQUETTE ® Frères) commercial pea protein.

The following protocol is applied:
Pour the water into a Stephan-type cooker
Heat to 50° C.
Add powders except the citric acid
Mix for 2 minutes, stirring at 750 rpm
Adjust pH to 4.5 with the citric acid.
Mix for 1 minute at the same speed and readjust the pH to 4.5 if necessary.
Heat to 75° C.
Pour the molten mass into a silicone mold and place in the refrigerator (4° C.)

Both cheeses have a high melting capacity, a desirable characteristic for this type of application. The shreddability of the cheeses is excellent in both cases, with the protein of the invention allowing them to be shredded in a longer form than in the case of the commercial protein.

### Plant-Based Alternative to Cheese Spread

The cheese spreads were manufactured using the recipes hereunder:

TABLE 8

| Ingredient | Recipe 1 (%) | Recipe 2 (%) | Recipe 3 (%) |
|---|---|---|---|
| Demineralized water | 70.9 | 71.2 | 70.6 |
| Pea protein of example 1 | 7.1 | 0 | 0 |
| Pea protein of example 2 | 0 | 6.8 | 0 |
| NUTRALYS ® S85F pea | 0 | 0 | 7.4 |
| protein | | | |
| Sunflower oil | 10.0 | 10.0 | 10.0 |
| NUTRIOSE ® FM06 | 7.5 | 7.5 | 7.5 |
| soluble fiber | | | |
| Citrus fiber | 3.0 | 3.0 | 3.0 |
| Sucrose | 1.0 | 1.0 | 1.0 |
| Salt (NaCl) | 0.5 | 0.5 | 0.5 |
| Ferments | qs | qs | qs |

All the cheeses produced have an amount of pea protein and water selected so as to contain 6% of protein.

In a Hotmix-type mixer fitted with a butterfly-type mixing paddle, the following protocol was carried out:
1. Heat the water to 55° C. and mix at 300 rpm
2. Add the pea protein and mix for 20 minutes at 300 rpm
3. Add the other ingredients in powder form and mix for 2 minutes at 300 rpm
4. Add the oil and stir for 2 minutes at 800 rpm
5. Heat to 95° C. under stirring at 300 rpm, then hold for 5 minutes at this temperature
6. Cool to 43° C. and stir at 300 rpm
7. Add the ferments (Vega Harmony, 0.1 mL for 500 mL)
8. Place in an oven at 43° C., until reaching a pH of 5.0
9. Smooth with the Hotmix for 30 seconds at 300 rpm
10. Package and store at 4° C.

The fermentation time was about 3:25 h for all the trials. The color of the cheeses is quite satisfactory.

The cheeses of the invention had an improved taste compared to that prepared using the commercial protein. Among the trials, only cheese 2 had a texture close to that of a commercial cheese spread, the other two being slightly more liquid and less gelled.

### Texturizer-Free Yogurt

### Preparation

The yoghurt was produced using the recipe hereunder:

TABLE 9

| Ingredient | % |
|---|---|
| Demineralized water | 88.9 |
| Pea protein of example 1 | 4.3 |
| Sunflower oil | 2.6 |
| Cane sugar | 4.2 |
| Ferments | qs |

The pea protein of the invention is evaluated along with the NUTRALYS ® S85F (ROQUETTE ® Frères) commercial pea protein.

The following protocol is applied:
1. Heat the water to 55° C.
2. Add the pea protein under moderate stirring (480 rpm) and hydrate for 30 minutes
3. Add the cane sugar and stir for 5 minutes at the same stirring speed
4. Add the sunflower oil, mix for 5 minutes at 1800 rpm
5. Place the mixture in a NIRO PANDA high-pressure homogenizer heated to 60° C. (first stage 105 bar, second stage 45 bar (upstream) at 150 bar
6. Pasteurize at 95° C. for 10 minutes while stirring at 800 rpm
7. Cool to 42° C. and add the lactic ferments
8. Maintain at 42° C. until the pH is 4.6
9. Pass through an IKA Magic Lab smoother equipped with 4M and 2G modules
10. Package and store at 4° C.

The texturizer-free yoghurt of the invention has a soft or even liquid texture. It appears creamier and more velvety than the texturizer-free yoghurt manufactured using the commercial protein.

It is also possible to add a conventional texturizing agent to improve the texture and make the yogurt more jelly-like than creamy.

### Emulsified Plant-Based Sausage

A plant-based sausage model is manufactured according to the following recipe:

The pea protein of the invention is tested in this model.

| Ingredient | % |
|---|---|
| Water | 31.5 |
| Crushed ice | 25.2 |
| Pea protein of example 1 | 14.8 |
| Wheat gluten | 3.0 |
| Egg white | 1.5 |
| Methyl cellulose | 1 |
| Sunflower oil | 16.3 |
| Native potato starch | 5.9 |
| Salt | 0.8 |

Approximately 1.5 kg of emulsified sausage model is prepared using the following method:
In a Stephan mixer cooled to 4° C. fitted with emulsion blades, disperse the crushed ice in water, stir at 750 rpm and place under vacuum, and increase the speed to 1500 rpm
Gradually add the oil and the methylcellulose, then mix under vacuum for 5 minutes at the same speed.
Add the protein and continue to mix for 5 minutes at the same speed Add the remaining ingredients and stir at the same speed for 5 minutes
Place 140 g of mixture in metal cans and seal
Heat for 1 hour at 100° C. (70% relative humidity)
Cool in cold water
Freeze

For tasting, the cans are reheated in hot water (100° C. for 20 minutes).

The texture of the sausages of the invention is excellent and has no marked taste, demonstrating that the protein of the invention can advantageously be used in this application.

### Evaluation of Pea Protein in Wet Extrusion

A powder mix is produced consisting of 3% of potato starch, 5% of ROQUETTE® I50M pea fiber and 92% of pea protein, the proportions being given by weight.

The pea proteins tested are those of example 1, example 2 and the commercial NUTRALYS® F85M pea protein.

This mixture is introduced by gravity into a LEISTRITZ ZSE 27MAXX extruder from LEISTRITZ.

The mixture is introduced with a regulated flow rate of about 13.3 kg/h. An amount of about 15.3 kg/h of water is also introduced. The humidity in the extruder is about 56%.

The wet extrusion tests were carried out on this extruder equipped with a thermoregulated die, model FDK750 from Coperion, comprising two modules with a length of 80 cm, with a flow area of 50 mm×15 mm, the second module of which is thermoregulated at 30° C. The extrusion screw is rotated at a speed equal to 350 rpm and sends the mixture into the die.

The temperature profile of the extruder, equipped with 15 cylinders that can be heated, is detailed hereunder:

TABLE 11

| | Z15 | Z14 | Z13 | Z12 | Z11 | Z10 | Z9 | Z8 | Z7 | Z6 | Z5 | Z4 | Z3 | Z2 | Z1 |
|---|---|---|---|---|---|---|---|---|---|---|---|---|---|---|---|
| Temp. | 120 | 120 | 130 | 150 | 150 | 130 | 100 | 90 | 80 | 60 | 60 | 60 | 35 | 35 | x |
| profile | | | | | | | | | | | | | | | |

The textured protein thus produced is cut at the outlet of the die into 10 cm strips.

The extrusion parameters for the 3 tests are shown hereunder:

TABLE 12

| | | | NUTRALYS ® |
|---|---|---|---|
| Pea protein | Example 1 | Example 2 | F85M |
| Torque (%) | 10 | 12 | 10 |
| Pressure (bar) | 16 | 14 | 11 |
| Material temp. (° C.) | 97 | 118 | 115 |
| (SME (Wh/kg)) | 33 | 35 | 30 |

### Band Observation

As regards the test carried out using the protein of example 2, the HME bands obtained have very good fibration. These bands have numerous fine fibers. They also have good elasticity.

The bands obtained from the protein of example 1 have less fibration than those of example 2. Under the preparation conditions of the example, the HME bands obtained using the commercial protein also have less fibration than those of example 2.

1. A method for producing pea protein comprising the following steps:
a) introducing peas or milled peas into an aqueous solution having a temperature between 65° C. and 90° C. in order to obtain a water/pea suspension or a water/milled pea suspension;
b) heat treating the suspension obtained in step a) at a temperature between 40° C. and 65° C. for 1 to 10 min;
c) in the case of a water/pea suspension, wet milling the water/pea suspension obtained in step b) in order to obtain an aqueous suspension of milled peas;
d) extracting a protein fraction by solid-liquid separation from the aqueous suspension of pea obtained in step b) or c);
e) optionally adjusting said protein fraction obtained in step d) to a pH between 2.0 and 8.0, for example between 4.5 and 5.7;
f) heat treating the protein fraction obtained in step e) at a temperature ranging from 65 to 90° C. for a time ranging from 1 to 120 seconds in order to form a coagulated pea protein suspension;
g) performing solid-liquid separation of the suspension of coagulated proteins obtained in step f) in order to form the pea protein.

2. The method according to claim 1, wherein the extraction step d) is preceded by a step d0) of cooling the suspension to a temperature below 15° C., preferentially to a temperature of 4° C. to 14° C., for example of 10° C. to 12° C.

3. The method according to claim 2, wherein the cooling step d0) is carried out by passing the aqueous suspension of milled peas through a heat exchanger.

4. The method according to claim 1, further comprising following the heat treatment step f), a step f1) of cooling the suspension of coagulated proteins by flash-cooling.

5. The method according to claim 1, further comprising a step of adjusting the pH of the pea protein to a pH of between 6 and 7.5, preferably between 6.5 and 7.5.

6. The method according to claim 1, further comprising a step of additional heat treatment of the pea protein.

7. The method according to claim 1, further comprising a step of shearing the pea protein, for example by passing through a high-pressure pump.

8. The method according to claim 1 further comprising a step of homogenizing the pea protein.

9. The method according to claim 1, further comprising a step of drying the pea protein.

10. The method according to claim 1, wherein the pH of the aqueous solution of step a) is adjusted between 8 and 10.

11. The method according to claim 1, wherein the duration of the heat treatment of the protein fraction is between 1 and 45 seconds, most preferentially between 1 and 10 seconds.

12. The method according to claim 1, wherein the milled peas of step a) are obtained by dry milling.

13. The method according to claim 1, wherein a fraction rich in pea starch and/or a fraction rich in pea fiber is recovered from the insoluble part resulting from the solid-liquid separation step d).

14. A pea protein that can be obtained by the method according to claim 1.

15. The pea protein according to claim 14, wherein the pea protein is not enzymatically modified by deamidation, preferably not enzymatically modified.

16. The pea protein according to claim 14, wherein at least one of its first three CATA descriptors determined according to ISO 5492: 2008 (en), 4.23 is a milky descriptor.

17. A use of pea protein according to claim 14 for producing food or beverage products, especially plant-based alternatives to milk.
